(19) United States
(12) Patent Application Publication
(10) Pub. No.: US 2024/0251381 A1
(43) Pub. Date: Jul. 25, 2024

(54) SYSTEM AND METHOD FOR OPTIMIZING ENERGY CONSUMPTION FOR GEOLOCATION DETECTION

(71) Applicant: HOOPO SYSTEMS LTD., RAANANA (IL)

(72) Inventor: Ilan LOZOVSKY, KFAR-SIRKIN (IL)

(21) Appl. No.: 18/564,109

(22) PCT Filed: Aug. 8, 2022
(86) PCT No.: PCT/IB2022/057364

§ 371 Date: Nov. 27, 2023

Related U.S. Application Data
(60) Provisional application No. 63/231,275, filed on Aug. 10, 2021.

(51) Int. Cl. H04W 64/00; H04W 48/08; H04W 52/02

(52) U.S. Cl. CPC H04W 64/006; H04W 48/08; H04W 52/0254

(57) ABSTRACT

Minimizing energy consumption of a device by selecting one of multiple location-determining apparatus assembled with the device and determining location-related data related to a location of the device using the selected location-determining apparatus, where each of the location-determining apparatus operates at a known location-determining-related energy consumption level and at a known accuracy level, and the selecting is performed by selecting one of the apparatus that operates at a lowest location-determining-related energy consumption level and at at least a required accuracy level.

### FIELD

The invention relates to tracking and monitoring in general, and more specifically to tracking assets having no source of power.

### BACKGROUND

Non-motorized equipment designed to be moved from one location to another (e.g., trolleys, chassis, trailers, dumpsters, and the like) need to be managed, and the location of each piece of equipment needs to be known. Due to the lack of inherent power-source on-board the equipment, a battery-operated device, capable of transmitting location related information may be installed on each piece of equipment and provide the needed information.

The energy consumption of the device in performing the various operations affects the battery life, therefore reducing energy consumption is critical. There is therefore a continuing need for improved tracking devices and systems using energy saving location assessment and energy saving transmission methods.

### SUMMARY

There is provided in accordance with an embodiment of the invention a method for minimizing energy consumption of a device, the method including selecting one of a plurality of location-determining apparatus assembled with the device, where each of the plurality of location-determining apparatus operates at a known location-determining-related energy consumption level and at a known accuracy level, and wherein the selecting is performed by selecting one of the plurality of location-determining apparatus that operates at a lowest location-determining-related energy consumption level among the plurality of location-determining apparatus, and operates at at least a required accuracy level. The method also includes determining location-related data related to a location of the device using the selected location-determining apparatus assembled with device.

Additionally, in accordance with an embodiment of the invention, the method includes detecting a presence of any of a plurality of available communication networks accessible to the device, selecting one of a plurality of communication apparatus assembled with the device, where each of the plurality of communication apparatus operates at a known transmission-related energy consumption level, and wherein the selected apparatus is configured to transmit via at least one of the available communication networks and operates at a lowest transmission-related energy consumption level among the plurality of communication apparatus, and transmitting the location-related data using the selected communication apparatus.

Moreover, in accordance with an embodiment of the invention, the selecting step is performed responsive to sensing a change in a physical condition of the device.

Furthermore, in accordance with an embodiment of the invention, the physical condition is any of a start of motion of the device and a cessation of motion of the device.

Still further, in accordance with an embodiment of the invention, the method includes at a first point in time, storing a first instance of location-related-data, and at a later point in time after the first point in time, determining the required accuracy level using the first instance of location-related-data.

Additionally, in accordance with an embodiment of the invention, the method includes determining the required accuracy level based on the available communication networks, where each of the available communication network is associated with a recommended accuracy level, and the required accuracy level is the recommended accuracy level of one of the available communication networks accessible to a communication apparatus that operates at a lowest transmission-related energy consumption level.

Moreover, in accordance with an embodiment of the invention, the method includes receiving a list of available communication networks, and where the detecting includes extracting the available communication networks from the list.

Additionally, in accordance with an embodiment of the invention, the method includes receiving a list of location determination assisting entities, each associated with an identifier and a location, and the detecting step includes extracting the location from the list.

There is provided in accordance with an embodiment of the invention a device that includes a plurality of location-determining apparatus each operating at a known location-determining-related energy consumption level and at a known accuracy level and a memory and a processor to select one of a plurality of location-determining apparatus that operates at a lowest location-determining-related energy consumption level among the plurality of location-determining apparatus, and operates at at least a required accuracy level, and determine location-related data correlated to a location of the device using the selected location-determining apparatus.

Additionally, in accordance with an embodiment of the invention, the includes a plurality of communication apparatus, each operating at a known transmission-related energy consumption level and where the processor is configured to detect a change in a physical condition of the device, detect a presence of any of a plurality of available communication networks accessible to the device, select one of a plurality of communication apparatus that is configured to transmit via at least one of the available communication networks and operate at a lowest transmission-related energy consumption level among the plurality of communication apparatus, and transmit the location-related data using the selected communication apparatus.

Furthermore, in accordance with an embodiment of the invention, the physical condition is any of a start of motion of the device and a cessation of motion of the device.

Still further, in accordance with an embodiment of the invention, the processor is configured to at a first point in time, store a first instance of location-related-data, and at a later point in time after the first point in time, determine the required accuracy level using the first instance of location-related-data.

Additionally, in accordance with an embodiment of the invention, the processor is configured to determine the required accuracy level based on the available communication networks, where each of the available communication network is associated with a recommended accuracy level, and the required accuracy level is the recommended accuracy level of one of the available communication networks accessible to a communication apparatus that operates at a lowest transmission-related energy consumption level.

Moreover, in accordance with an embodiment of the invention, the processor is configured to receive a list of available communication networks and use the list to detect the available communication networks.

Further, in accordance with an embodiment of the invention, the processor is configured to receive a list of location determination assisting entities, each associated with an identifier and a location, and determine location-related data using the list.

### BRIEF DESCRIPTION OF THE DRAWINGS

The invention will now be described in relation to certain examples and embodiments with reference to the following illustrative drawing figures so that it may be more fully understood. In the drawings:

FIG. 1 is a schematic illustration of the environment where embodiments of the invention may operate;

FIG. 2 is a schematic illustration of a device that provides location related data, constructed and operative in accordance with an embodiment of the invention;

FIG. 3 is a is a flow that may be implemented by processor device to detect and transmit location related data according to an embodiment of the invention; and

FIG. 4 is a schematic illustration of an application operating with the devices and provide the location of the devices, constructed and operative in accordance with an embodiment of the invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate the same or analogous elements.

### DETAILED DESCRIPTION

In the following description, various aspects of the invention will be described. For purposes of explanation, specific configurations and details are set forth in order to provide a thorough understanding of the invention. However, it will also be apparent to one skilled in the art that the invention may be practiced without one or more specific details presented herein. Furthermore, well known features may be omitted or simplified in order not to obscure the invention.

Embodiments of the invention provide systems and methods for optimizing battery consumption of battery-operated devices capable of providing reliable location related information and an application capable of determining geographic location (longitude and latitude) in a required accuracy level (e.g., high accuracy—few meters, moderate accuracy—10 meters, low accuracy—30 meters or any other split of accuracy to levels) from the provided location related information.

Embodiments of the invention provide devices and an application with which the devices communicate. The devices are equipped with various location-determining apparatus capable of determining location related information and with various communication apparatus, each capable of transmitting the information over a communication network operating with a specific communication technology. In some cases, the same technology is used for location detection and transmission and in these cases, a single apparatus may be used for both.

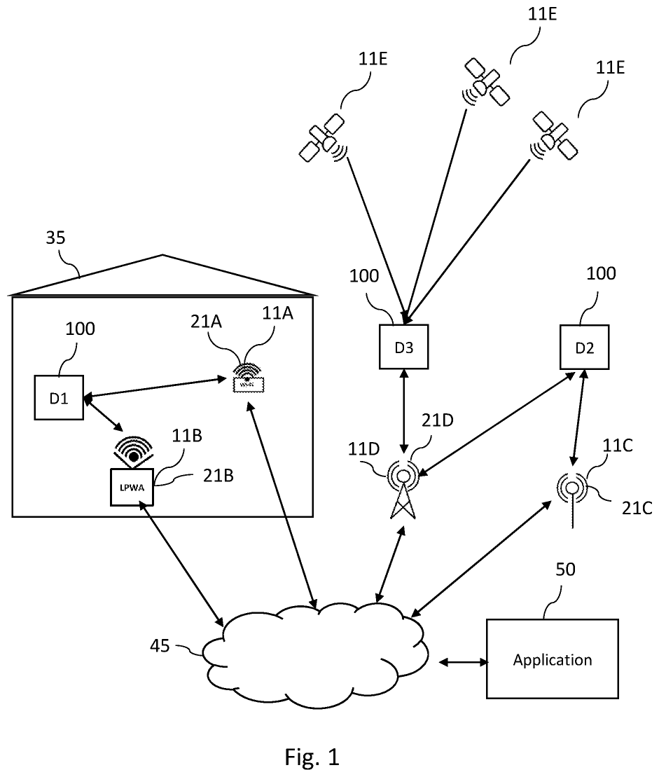

FIG. 1, to which reference is now made, is a schematic illustration of the environment where embodiments of the invention may operate. The environment includes a plurality of devices 100 (D1, D2 and D3) (each installed on a non-motorized equipment designed to be moved from one location to another, not shown in the figure), a plurality of locating assisting entities 11, a plurality of communication entities 21, a network 45 and an application 50.

Devices 100 may communicate over the air with various location determination assisting entities 11 that provide location related information from which a location can be determined and may communicate over the air with various entities 21 that provide communication services over various communication networks and enable devices 100 to communicate over network 45 with application 50. Application 50 may receive information from devices 100 from which it may determine their location and may send information to devices 100 to enable configuration and provide information to minimize energy consumption of devices 100.

Examples of location determination assisting entities 11, that may provide location related information and may be part of larger systems capable of providing the location of a device 100 are satellites 11E that are part of the global navigation satellite system (GNSS) that provide a geographic location (longitude and altitude) (e.g., GPS, GALILEO or GLONASS); Wi-Fi access points 11A that are part of the Wi-Fi Positioning Systems (WPS), that uses Wi-Fi sniffing from which location can be determined; low-power wide-area network (LPWA) entities 11B (with for example Native LoRa Location System) and Bluetooth low energy (BLE) entities 11C that provide a beacon ID from which the location can be determined; a cellular cell 11D operating as part of a Cellular Positioning over Long Term Evolution (PoLTE) system that provides cellular location for 4G and 5G IoT devices, or as part of any cellular network that may provide a cell ID from which a location may be determined.

Examples of entities 21 that provide communication capabilities are Wi-Fi access point 21A, LPWA entity 21B, BLE entity 21C and cellular 21D operates in a cellular data network (Long Term Evolution (LTE)/Narrowband Internet of things (NB-IOT)).

It may be noted that devices 100 may communicate over the air with various entities, each capable of providing location related information and/or communication service. Some systems (e.g., entity 11E (GPS)) may provide only location related information and not communication service and some systems (e.g., entities 21A (Wi-Fi), 21B (LPWA), 21 C (BLE) and 21D (cellular)) may provide both. Entities capable of providing both capabilities are assigned in the illustration two references numerals, one indicating its location related functionality (11) and the other indicating it communication functionality (21).

It may be noted that a device 100 may be located indoors (in building 35) or outdoors where the connectivity with various location determination assisting entities 11 and communication entities 21 may differ. For example, a device 100 (D1) located indoors may not be exposed to GPS signals.

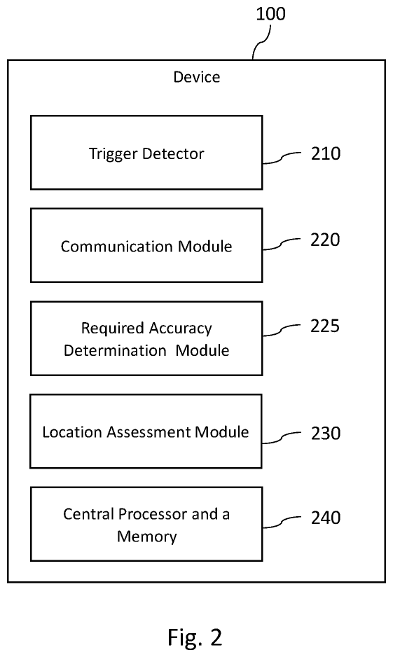

FIG. 2, to which reference is now made is a schematic illustration of device 100, constructed and operative in accordance with an embodiment of the invention. Device 100 includes a trigger detector 210, a communication module 220, a required accuracy determination module 225, a location assessment module 230 and a processor 240.

Trigger detector 210 may detect a situation where device 100 is required to detect and transmit its location. Trigger detector 210 may raise a trigger when the detected condition complies with a predefined state. The condition may be a logical (e.g., time elapsed) or physical (e.g., motion initiation).

Trigger detector 210 includes a plurality of apparatus containing sensors, each sensor may sense a physical state and each apparatus may detect a change in the physical state of the device.

The physical states may for example be motion, surrounding light, surrounding sound, location, or any other physical parameter of the environment that may be sensed and evaluated by a sensor. The change in the physical state may be for example initiation of or cessation of motion, an increase or decrease of velocity, an increase or decrease of light intensity, an increase or decrease of sound volume, a change in geographic location and the like.

Each apparatus may also compare a physical state with predefined conditions or thresholds and may inform trigger detector 210 when a certain condition has been met or a certain threshold has been crossed. For example, the conditions may be if the light intensity is equal to or above a certain threshold, or if the velocity is equal to or above a certain threshold, or if the location changed from a first location to a second location during a predefined period and the like.

The logical conditions may for example be time elapsed from last transmission, request for transmission was received (e.g., from application 50) and the like.

Trigger detector 210 may be configured to raise a trigger when either receiving an indication form one of the apparatus indicating that a physical condition is met or when receiving an indication that a logical condition is met (e.g., from central processor 240) or any combination of physical and logical conditions.

For example, when device 100 is installed on a container that is loaded on a ship, trigger detector 210 may be configured not to raise a trigger when detecting an initiation of movement. Device 100 may be aware of it being on board of a ship (by for example detecting a transmission from an entity (e.g., beacon ID of an LPWA beacon) that is known to be installed on the ship.

Communication module 220 includes a plurality of communication apparatus assembled with device 100. Each communication apparatus operates using a different communication technology and may operate at a transmission-related energy consumption level.

Transmission-related energy consumption level may depend on may depend on the power used for a transmission and the duration of the transmission. More power and/or longer durations may increase the energy consumption of device 100, and each communication apparatus may have several transmission-related energy consumption levels, for the various conditions affecting the power and/or duration.

Transmission-related energy consumption level may depend on different environmental conditions, and each communication apparatus may have several transmission-related energy consumption levels, one for each environmental condition. For example, cellular IoT solutions may consume different amount of energy depending on their location, when located indoors their transmission-related energy consumption is higher than when located outdoors.

Communication module 220 may select a communication apparatus prior to each transmission based on the available communication networks (at the transmission time) and the transmission-related energy consumption level of the apparatus. If multiple communication networks are available, communication module 220 may select the one with the lowest transmission-related energy consumption level that has access to one of the available communication networks.

To minimize energy consumption when searching for available networks, communication module 220 may have a list of preferred networks (to avoid searching for available ones by activating the various apparatus and trying to connect to each possible network, an action that consumes energy) and select an apparatus working with one of the networks included in the list. The list of networks may be provided to device 100 by application 50 as described hereinbelow.

Each of the various communication apparatus may use a different communication technology such as BLE, Wi-Fi, LPWA, IoT solutions such as category M (Cat-M) Narrowband IoT (NB-IOT), extended coverage GSM IoT (EC-GSM), cellular technology (including data networks LTE/Narrowband IoT NB-IOT) or any other communication technology.

Device 100 may have a configuration of the available communication apparatus ordered by their transmission-related energy consumption level and may try the communication apparatus in order until transmission is possible. In one embodiment the order may be (from lowest transmission-related energy consumption level to highest) BLE, Wi-Fi, LPWA, Cat-M, NB-IOT, EC-GSM, cellular.

Communication module 220 may select the communication apparatus according to availability and pre-defined rules. The rules may be related to the amount of energy consumption, i.e., may define the maximum transmission-related energy consumption allowed for a specific transmission. One of the rules may be “having the lowest transmission-related energy consumption level in the relevant environment condition and succeed to establish connectivity with a communication network”.

On each occasion, where a communication is needed (device 100 needs collect and transmit location related information), communication module 220 may be configured to select a communication apparatus and in each case, a different one may be selected.

Required accuracy determination module 225 may define the required accuracy level prior to each location assessment action. The required accuracy level may change from one occasion to another and may depend on various states and conditions related to device 100. Required accuracy determination module 225 may consider the needed accuracy level and the available means (networks from which signals may be detected) when determining the required accuracy level.

In some cases, the required accuracy level may be dictated by application 50 that may send a request to a device 100 to provide its location and may determine the required accuracy level for that specific request.

The determined required accuracy level may affect the list of potential location-determining apparatus that may be used for each activity of determining location-related data.

When device 100 initiates a transmission of its location (i.e., after detecting a trigger) required accuracy determination module 225 may determine the required accuracy level based on current and past location. For example, when device 100 is located indoors (i.e., inside a hangar or a depot), GPS may not be available and required accuracy determination module 225 may define the required accuracy level to be low to avoid using the GPS apparatus and prevent attempts that may fail to receive GPS signals that may lead to unnecessary energy consumption.

Another example is when device 100 is located indoors, but at the border of a building (e.g., hangar). In This case, device 100 may receive GPS signals in addition to Wi-Fi and/or BLE and required accuracy determination module 225 may define the required accuracy level to be high to enable the usage of the GPS apparatus and improve location accuracy.

Location assessment module 230 includes a plurality of location-determining apparatus assembled with the device. Each location-determining apparatus operates using a different technology and may operate at a known location-determining-related energy consumption level and at a known accuracy level.

Each location-determining apparatus may exploit any of the available systems capable of providing location information data from which a location can be determined: GNSS, BLE/LPWA, Wi-Fi, Native LoRa Location System, Cellular PoLTE System, cellular cell ID and the like.

The various systems provide location related information that may result in a more or less accurate information. For example, the known accuracy level of LPWA/BLE may be high, of Wi-Fi may be moderate and of cellular may be low.

In some cases, when accurate location is not needed, location assessment module 230 may use an apparatus with a low location-determining-related energy consumption level has connectivity with a communication network. In other cases, when a high location accuracy is needed, location assessment module 230 may select an apparatus with a high location-determining-related energy consumption level, and even several ones to improve location accuracy at the expense of increased energy consumption.

For example, the accuracy level of GPS is high, and it also consumes a lot of energy (especially when failing to receive GPS signals) so when the required accuracy level is not high it may be better not to use GPS and location assessment module 230 may select another location-determining apparatus that may provide less accurate location that may be sufficiently good for that occasion while consuming low amount of energy.

Another example may be when accurate location is not needed and location assessment module 230 may select a location-determining apparatus that use a technology that is less accurate but consumes less energy, such as cellular cell ID (instead of using GPS that is more accurate but consumes more energy).

Location assessment module 230 may select the location-determining apparatus prior to each location assessment activity according to the required accuracy level for that specific activity and a set of pre-defined rules. The rules may be pre-configured or may be controlled by application 50 that may add, delete, or modify the rules when needed.

Location assessment module 230 may select a location-determining apparatus by trying to determine the lowest power demanding location-determining apparatus applicable from the ones that has connectivity having a known location accuracy that is equal or higher than the required accuracy.

Device 100 may be configured with the available location-determining apparatus ordered by energy consumption and may try to use then in order until communication is possible.

In one embodiment the order may be (from lowest transmission-related energy consumption level to highest) LPWA/BLE (getting beacon ID (e.g., LoRa or BLE)), Wi-Fi Sniffing, GNSS (Satellite) (e.g., GPS), Cellular based (e.g., PoLTE), and Cellular cell ID.

Examples of rules location assessment module 230 may apply for selecting a location-determining apparatus prior to a location detection activity may be:

If beacon (BLE/LPWA) or Wi-Fi MAC ID, known to be installed indoors, are detected then don't use GPS.

If the required accuracy level is lower than a predefined threshold, then don't use GPS.

If the prior location-related-data indicates the location is indoors, then don't use GPS.

If the prior location-related-data indicates the location is indoors, and the required accuracy level is high then use both PoLTE and Wi-Fi sniffing.

If cellular (e.g., Cat-M) is detected, indicating the location is outdoors, and the required accuracy level is high then use GPS.

If devices 100 operate outdoors is an urban location and Wi-Fi is detected, then use Wi-Fi sniffing and if cellular is detected then use cell ID or Cellular PoLTE location utilizing cellular Cell IDs listed in the device.

In specific predetermined locations, if the required accuracy level is low or moderate, and a movement longer than a threshold has been detected use GPS.

In specific predetermined locations, if the required accuracy level is low, use LPWA.

It may be noted that the rules may include various aspects and features such as past location-related-data, available communication networks, required accuracy level, detected trigger and other information saved in device 100 or known by application 50.

Location assessment module 230 may have multiple rules different situations and application 50 may add, modify or delete rules and may utilise various techniques to learn the environment where devices 100 are operating and to handle new locations and situation.

Processor 240 may include a memory apparatus and may control the operation of all modules of device 100.

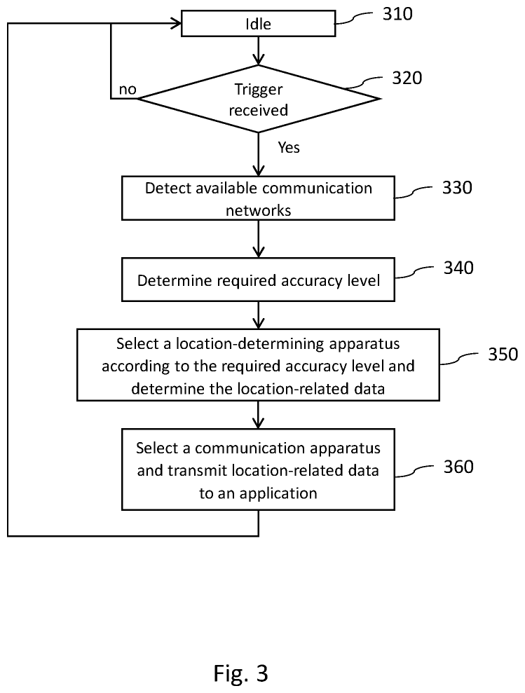

FIG. 3, to which reference is now made, is a flow that may be implemented by processor 240, according to an embodiment of the invention. Processor 240 may perform energy consuming activities such as location assessment and transmission only when needed, after a trigger is detected, and may select the most effective apparatus to perform the needed activity.

In step 310, processor 240 may wait in an idle state (minimizing energy consumption). In step 320, processor 240 may check if trigger detector 210 has detected a trigger, if not processor 240 may return to the idle state in step 310. If a trigger has been detected, processor 240 may move to step 330 and activate communication module 220 to detect available communication networks. As described hereinabove, numerus communication apparatus may be assembled with device 100 but device 100 needs to detect with which communication networks it may communicate.

In step 340, processor 240 may activate accuracy determination module 225 to get the value of the required accuracy level prior to collecting the location related information and in step 350, processor 240 may activate location assessment module 230 to select one or more location-determining apparatus according to the available communication networks and required accuracy level (and according to the rules that ensure selecting energy apparatus that operates with the minimum location-determining-related energy consumption level and at the required known accuracy level, in a specific condition) and determine the location-related data related to a location of device 100.

In step 350, processor 240 may activate communication module 220 to select a communication apparatus and transmit location-related data to an application. After completing the transmission processor 240 may return to the idle state 310.

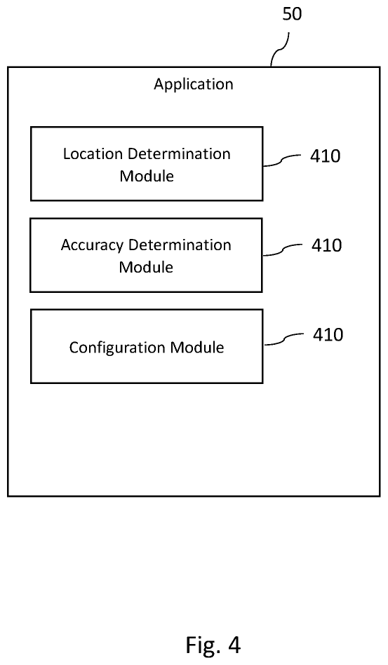

FIG. 4, to which reference is now made, is a schematic illustration of application 50, constructed and operative in accordance with an embodiment of the invention. Application 50 may receive location-related data from a plurality of devices 100 and may determine the location of each device 100. In addition, application 50 may send information to device 100 to control the device and or assist in minimizing energy consumption.

Application 50 includes a location determination module 410, an accuracy determination module 420 and a configuration module 430.

Location determination module 410 may receive location-related data from a device 100 and may provide the location of the device.

When the location-related data includes GPS data, the location is available from the GPS longitude and latitude.

For BLE and LPWA, location determination module 410 may have access to the location of all beacons installed in the environment where devices 100 are operating.

When the location-related data is BLE/LPWA beacons ID, the location determination module 410 may determine the location of device 100 from the know location of the beacons.

When operating with LPWA, location determination module 410 may use Native LoRa Location System to detect the location of the beacons.

For cellular and PoLTE systems location determination module 410 may have access to the location of the cells and from the cellular cell ID may determine the location of device 100.

Location determination module 410 may utilize artificial intelligence (AI) techniques to learn the location of devices 100, movement pattern of devices 100, characteristics of the location such as indoors or outdoors, association between WiFi addresses (indoor) and surrounding GPS (when WiFi location is unknown in advance) and the like, available networks, the MAC address of devices that appear to be part of a network and the like.

Location determination module 410 may utilize artificial intelligence (AI) to learn the location of various entities such as Wi-Fi access points and various beacons when their location is not accessible by application 50. For example, in an airport, the Wi-Fi network is not publicly known and application 50 may learn the location of the various access points and beacons using information received from devices 100, that may include for example GPS coordinates.

Accuracy determination module 420 may determine the required accuracy level based on information received in the past and the various AI activities. Accuracy determination module 420 may know that a device is located indoors and may therefore define the accuracy level to be low.

Configuration module 430 may send to device 100 configuration and data to the devices including rules controlling the activity of the various modules. Configuration module 430 may send a list of preferred networks to avoid searching for available ones.

Configuration module 430 may send a list of containing for each entity (e.g., Wi-Fi access points in private networks) a MAC addresses and a location.

Configuration module 430 may send additional information that may assist device 100 to minimize its energy consumption. The additional information may for example include the required accuracy level that may affect the selected network technology, a list of Wi-Fi MAC addresses and a list of BLE/LoRa Beacons.

Embodiments of the current invention provide a battery-operated device (that can be installed on non-motorized movable objects), that supports various communication technologies and can operate with various communication networks, the device can provide location-related data from which a location can be determined in a required accuracy using any of various location assessment methods and transmitting the data using any of the communication networks.

Each time the device needs to provide location-related data the required accuracy is determined, and the communication technology and the location method are selected to comply with the needed accuracy level while minimizing energy consumption.

The device operates (location assessment and transmission) only when needed (e.g., the location is changed).

The device selects the most efficient energy consumption methods for location assessment and communication while providing the needed location accuracy.

When the required location accuracy is low, the device may select methods that consume less energy and still provide valuable information (e.g., Wi-Fi, cell ID), applicable for the specific needs.

Compared with existing devices that provide the best possible location accuracy (or reaching a threshold of required accuracy) regardless of the needed accuracy, embodiments of the invention provide maximum energy efficiency with sufficiently location accuracy.

Embodiments of the invention provide devices that provide location-related data both indoors and outdoors with maximal efficiency for each combination of required accuracy and available connectivity.

Embodiments of the invention use energy efficient techniques to reduce battery consumption of the device and provide long operation before battery replacement is needed by selecting the lowest available energy consumption method to collect location related information in a required accuracy and selecting the lowest available energy consumption method to transmit the location related information to an application.

While certain features of the invention have been illustrated and described herein, many modifications, substitutions, changes, and equivalents will likely occur to those of ordinary skill in the art. It is, therefore, to be understood that the appended claims are intended to cover all such modifications and changes as fall within the true spirit of the invention.

It may be appreciated that the steps shown for the flows herein above are not intended to be limiting and that each flow may be practiced with variations. These variations may include more steps, less steps, changing the sequence of steps, skipping steps, among other variations which may be evident to one skilled in the art.

Unless specifically stated otherwise, as apparent from the following discussions, it is appreciated that throughout the specification discussions utilizing terms such as “analyzing”, “processing,” “computing,” “calculating,” “determining,” “detecting”, “identifying” or the like, refer to the action and/or processes of a computer or computing system, or similar electronic computing device, that manipulates and/or transforms data represented as physical, such as electronic, quantities within the computing system's registers and/or memories into other data similarly represented as physical quantities within the computing system's memories, registers or other such information storage, transmission or display devices.

What is claimed is:

1. A method for minimizing energy consumption of a device, the method comprising:
selecting one of a plurality of location-determining apparatus assembled with the device,
wherein each of the plurality of location-determining apparatus operates at a known location-determining-related energy consumption level and at a known accuracy level, and
wherein the selecting is performed by selecting one of the plurality of location-determining apparatus that
a) operates at a lowest location-determining-related energy consumption level among the plurality of location-determining apparatus, and
b) operates at at least a required accuracy level; and
determining location-related data related to a location of the device using the selected location-determining apparatus assembled with device.

2. The method of claim 1, further comprising:
detecting a presence of any of a plurality of available communication networks accessible to the device;
selecting one of a plurality of communication apparatus assembled with the device,
wherein each of the plurality of communication apparatus operates at a known transmission-related energy consumption level, and
wherein the selected apparatus is configured to transmit via at least one of the available communication networks and operates at a lowest transmission-related energy consumption level among the plurality of communication apparatus; and
transmitting the location-related data using the selected communication apparatus.

3. The method of claim 1 wherein selecting is performed responsive to sensing a change in a physical condition of the device.

4. The method of claim 3 wherein the physical condition is any of a start of motion of the device and a cessation of motion of the device.

5. The method of claim 1, further comprising:
at a first point in time, storing a first instance of location-related-data; and
at a later point in time subsequent to the first point in time, determining the required accuracy level using the first instance of location-related-data.

6. The method of claim 2 further comprising determining the required accuracy level based on the available communication networks,
wherein each of the available communication network is associated with a recommended accuracy level, and
wherein the required accuracy level is the recommended accuracy level of one of the available communication networks accessible to a communication apparatus that operates at a lowest transmission-related energy consumption level.

7. The method of claim 2, further comprising:
receiving a list of available communication networks; and
wherein the detecting comprises extracting the available communication networks from the list.

8. The method of claim 2, further comprising:
receiving a list of location determination assisting entities, each associated with an identifier and a location; and
wherein the detecting comprises extracting the location from the list.

9. A device comprising:
a plurality of location-determining apparatus each operating at a known location-determining-related energy consumption level and at a known accuracy level and
a memory and a processor to
select one of a plurality of location-determining apparatus that
a) operates at a lowest location-determining-related energy consumption level among the plurality of location-determining apparatus, and
b) operates at at least a required accuracy level; and
determine location-related data correlated to a location of the device using the selected location-determining apparatus.

10. The system of claim 9 further comprising:
a plurality of communication apparatus, each operating at a known transmission-related energy consumption level, and
wherein the processor is configured to
detect a change in a physical condition of the device,
detect a presence of any of a plurality of available communication networks accessible to the device,
select one of a plurality of communication apparatus that is configured to transmit via at least one of the available communication networks and operate at a lowest transmission-related energy consumption level among the plurality of communication apparatus; and
transmit the location-related data using the selected communication apparatus.

11. The system of claim 10 wherein the physical condition is any of a start of motion of the device and a cessation of motion of the device.

12. The system of claim 10, wherein the processor is configured to
at a first point in time, store a first instance of location-related-data; and
at a later point in time subsequent to the first point in time, determine the required accuracy level using the first instance of location-related-data.

13. The system of claim 10 wherein the processor is configured to
determine the required accuracy level based on the available communication networks,
wherein each of the available communication network is associated with a recommended accuracy level, and
wherein the required accuracy level is the recommended accuracy level of one of the available communication networks accessible to a communication apparatus that operates at a lowest transmission-related energy consumption level.

14. The system of claim 11 wherein the processor is configured to:
receive a list of available communication networks; and
use the list to detect the available communication networks.

15. The system of claim 9 wherein the processor is configured to:
receive a list of location determination assisting entities, each associated with an identifier and a location, and
determine location-related data using the list.
